(19) United States
(12) Patent Application Publication
(10) Pub. No.: US 2022/0120365 A1
(43) Pub. Date: Apr. 21, 2022

(54) FLANGE SEAL

(71) Applicant: Georg Fischer Rohrleitungssysteme AG, Schaffhausen (CH)

(72) Inventors: Edin HASIFIC, Schaffhausen (CH); Juergen ROESCH, Lenzkirch (DE)

(21) Appl. No.: 17/500,868

(22) Filed: Oct. 13, 2021

(30) Foreign Application Priority Data
Oct. 16, 2020 (CH) 01329/20

(51) Int. Cl. F16L 23/032; F16L 23/22

(52) U.S. Cl. CPC F16L 23/032; F16L 23/22

(57) ABSTRACT

Flange connection for connecting two pipeline ends made of plastics material and method for assembly, containing two mutually opposing pipe ends (2) made of plastics material, wherein the pipe ends each have a prewelding neck, two loose type flanges, wherein a loose type flange is arranged at each pipe end, wherein the loose type flanges have holes for mutual clamping, clamping means, wherein the clamping means are arranged in the holes and serve to mutually pull together the loose type flanges and the pipeline ends, and a sealing element, wherein the sealing element comprises a conductive plastics material and exclusively one material.

### CROSS-REFERENCE TO RELATED APPLICATIONS

This application claims the benefit and priority of Swiss Patent Application No. 01329/29 filed Oct. 16, 2020. The entire disclosure of the above application is incorporated herein by reference.

### BACKGROUND OF THE INVENTION

### Technical Field

The invention relates to a flange connection for connecting two pipeline ends made of plastics material containing two mutually opposing pipe ends made of plastics material, wherein the pipe ends each have a prewelding neck, two loose type flanges, wherein a loose type flange is arranged at each pipe end, wherein the loose type flanges have holes for mutual clamping, clamping means, wherein the clamping means are arranged in the holes and serve to mutually pull together the loose type flanges and the pipeline ends, and a sealing element.

### Discussion

WO 2016/184801 A1 discloses a flange connection in which the heating coils for heating the plastics material are arranged in the flanges and the two mutually facing end faces of the flanges are welded to each other directly and without an intermediate component.

GB 2 431 135 A also discloses a flange of a thermoplastic material in which a heating wire is incorporated at the end face and a sealing element which is arranged at the end face of the flange.

US 2003/0075919 A1 discloses a flange connection in which a welding insert is arranged between the prewelding necks of the pipe ends, wherein the welding insert contains a disc which is made of plastics material and which is surrounded by conductive wires in order to heat the plastics material and the pipe ends for welding.

U.S. Pat. No. 6,398,264 B1 discloses an apparatus for thermally activating or heating pipeline ends. In order to connect the pipeline ends tightly to each other, there is placed on the two end faces a heating element which heats the ends and to which at the same time a sealing agent which was previously fitted to the heating element is applied. This enables a sealed, end-face joining of the pipeline ends after the apparatus has been removed.

The disadvantage of the above-mentioned connections is that the flange connections become non-tight after a period of time since the plastics material begins to creep. This may, when mechanical clamping means are provided, be overcome by means of regular re-adjustment or re-tightening of the connection, wherein such flange connections are in most cases difficult to access with installed pipelines and re-tightening is possible only to a limited degree. Furthermore, the above-mentioned flange connections cannot be released for maintenance purposes and be screwed again or the same components reused since the components do not ensure any new sealing.

An aspect of the invention is to provide a flange connection and a related method for assembly such that the sealing is intended to be ensured over a longer period of time and such that the regular operations for re-tightening the flange connection are intended to be reduced. Furthermore, assembly errors and the fact that after a maintenance operation the same sealing element can no longer be used are intended to be prevented.

### SUMMARY

This aspect is achieved in that the sealing element comprises a conductive plastics material and exclusively one material.

The flange connection according to the preferred embodiment of the invention for connecting two pipelines made of plastics material contains two mutually opposing pipe ends made of plastics material. The pipe ends each have a prewelding neck. For the mutual clamping together of the two prewelding necks, a loose type flange is arranged at each pipe end. The loose type flanges have holes in which clamping means for mutually clamping together the loose type flanges are arranged. As a result of the pulling together of the loose type flanges, the pipe ends which are arranged concentrically therein are also accordingly mutually pulled together with the prewelding necks. In addition, the flange connection according to the invention contains a sealing element, wherein the sealing element comprises a conductive plastics material and exclusively one material. As a result of the conductive plastics material, the sealing element can be heated by means of supplied electric power. The sealing element consequently has no additional individual components or the sealing element is constructed in one piece. This has the advantage that no additional assembly complexity is required. Furthermore, it has the advantage that no wire discharge can occur as with conventional seals with an integrated heating wire. As a result of the fact that the sealing element is not only pressed on the prewelding necks, but is also welded thereon or welded thereto, a higher level of tightness of the flange connection is ensured.

The sealing element is preferably produced using the injection-moulding method and constructed as an injection-moulded component. The loose type flange which is used to clamp together the pipe ends may be constructed as a plastics component and as a metal component. Of course, the loose type flange may also be produced from a composite material.

Preferably, the conductive plastics material of the sealing element is constructed in a homogeneous manner. The sealing element thereby conducts the electric power in a uniform manner and is heated in a uniform manner. As a result of the heating of the sealing element, the material becomes softer and the sealing element adapts better to the surface of the end face of the prewelding necks and an optimum positive-locking connection is achieved between the sealing element and prewelding neck. In addition, with a specific material combination, between the sealing element and prewelding neck, a materially engaging connection can also be obtained in addition to the positive-locking connection.

It has been found to be advantageous for exclusively the sealing element to be arranged between the mutually opposing prewelding necks. This has the advantage that no additional components can be forgotten during the assembly and consequently the risk of an inadequate connection is reduced.

An electrically conductive thermoplastic elastomer material (TPE) is used as a preferred material for the sealing element. Preferably, the TPE is constructed in a resilient manner, whereby the sealing capacity is optimised. As a result of the heating by the power supplied, the sealing element made of thermoplastic elastomer material becomes softer and adapts optimally to the surface of the end face of the prewelding necks.

Preferably, contact elements preferably made of a conductive material for power supply are arranged on the sealing element, wherein the material does not have to be identical to the material of the sealing element.

A preferred embodiment has been found to be when the prewelding neck is made of polyethylene (PE). In combination with the sealing element of an electrically conductive thermoplastic elastomer material, the two plastics materials form a materially engaging connection, which in turn ensures the sealing of the flange connection according to the invention to an increased extent.

It has also been found to be advantageous for the prewelding neck to have grooves at the end face. When the connection is clamped together, the sealing element is pressed into the grooves and thereby ensures a positive-locking connection which withstands high pressures.

According to a preferred embodiment, the grooves are constructed in the prewelding neck as concentrically extending circles.

This aspect is achieved in that in the method for assembling a flange connection the sealing element is already arranged on the end face of a prewelding neck in a non-releasable manner before the loose type flanges are arranged at the mutually opposing pipe ends and the clamping together is carried out.

It has also been found to be advantageous for the sealing element to be able to be released by heating the prewelding neck again and, after the prewelding neck and the sealing element are cleaned, to be able to be used again.

The method according to the preferred embodiment of the invention for assembling a flange connection includes:

arranging the loose type flanges at mutually opposing pipe ends made of plastics material, clamping together the loose type flanges using clamping means, wherein the clamping together is carried out only up to a slight pretensioning.

Subsequently, an electric current is applied to a conductive sealing element, wherein the conductive sealing element is arranged between the pipe ends or the prewelding necks of the pipe ends. As a result of the supply of the current to the sealing element, a welding is achieved between at least one side of the sealing element and a prewelding neck. Subsequently, the clamping together of the loose type flanges using clamping means is carried out up to a required tightening torque. During the method according to the invention for assembling a flange connection, the conductive sealing element is already arranged on the end face of a prewelding neck in a non-releasable manner before the loose type flanges are arranged on the mutually opposing pipe ends and the clamping together is carried out. Preferably, the sealing element is already secured to the end face of a prewelding neck in the factory, this can already be carried out by heating the conductive sealing element by means of electric current and consequently a welding of the sealing element to the prewelding neck or, alternatively, the sealing element can also be secured provisionally with an adhesive or a mechanical securing means which is removed before the welding operation. This affords the advantage that the sealing element cannot be forgotten and the risk of assembly errors is thereby reduced. It is also ensured that the correct sealing element is used for the corresponding flange connection.

In the method according to the invention, the advantage is afforded that the sealing element can be heated again after a first heating, whether it be to remove the sealing element from the prewelding neck, wherein this can alternatively also be carried out without heating by means of separation, or for welding to the prewelding neck again, for example, as a result of a required adjustment of the flange connection as a result of a displacement of the pipeline or other adaptations.

All the embodiments can be freely combined with each other and features of the method can be applied to the flange connection and vice versa.

### DRAWINGS

An embodiment of the invention is described with reference to the Figures, wherein the invention is not limited only to the embodiment. In the drawings:

FIG. 1 is a sectioned illustration of a flange connection according to the invention, and

FIG. 2 is a three-dimensional illustration of a flange connection according to the invention.

### DESCRIPTION OF THE PREFERRED EMBODIMENTS OF THE INVENTION

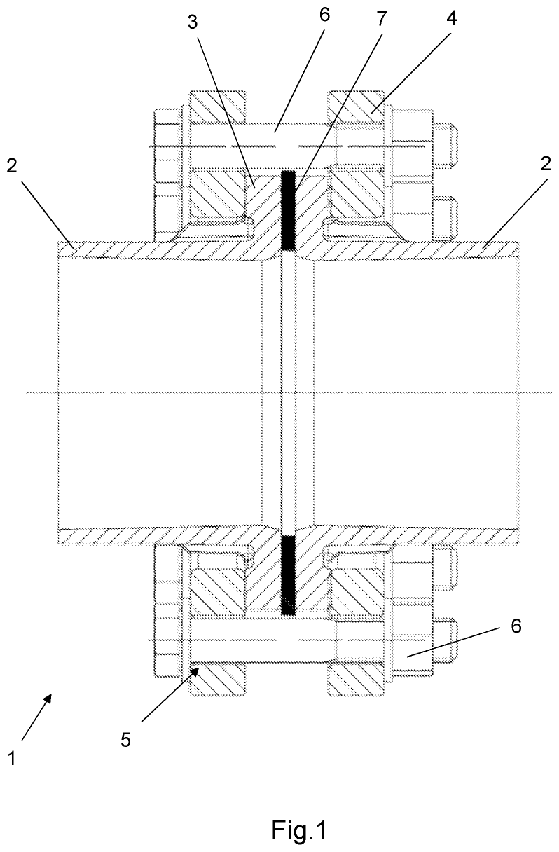

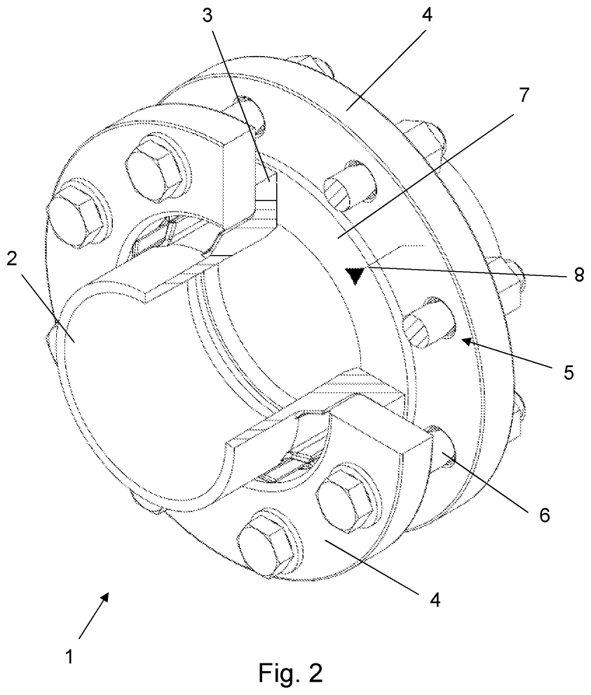

The drawing depicted in FIG. 1 is a sectioned view of a flange connection 1 according to the invention for connecting pipeline ends made of plastics material. The flange connection 1 contains two mutually opposing pipe ends 2 made of plastics material, wherein the pipe ends are arranged concentrically relative to each other. The pipe ends 2 each have a prewelding neck 3 by means of which they are mutually clamped together, this can also be clearly seen in FIG. 2. There are arranged in each case at the pipe ends 2 loose type flanges 4 which are mutually clamped together using clamping means 6. The prewelding necks 3 of the pipe ends 2 are arranged between the loose type flanges 4 and are pressed together thereby. The clamping means 6 are arranged in the holes 5 in the loose type flanges 4 provided for this purpose and are preferably distributed in a uniform manner. A sealing element 7 is arranged between the two prewelding necks 3, wherein the sealing element 7 comprises a conductive plastics material. In order to improve the sealing, the sealing element 7 is heated by means of electric current, which in turn makes the material of the sealing element 7 softer and it thereby fits better against the end faces of the prewelding necks 3 when the flanges are clamped and seals correspondingly well. For power supply, contact elements 8 which are arranged on the sealing element 7 are used. The contact elements 8 are illustrated purely schematically in FIG. 2, the configuration thereof is developed in accordance with the connection possibilities or the accessibility of the flange connection. In addition to the optimum positive-locking connection achieved thereby, with a corresponding material selection of the sealing element and prewelding neck 3 a materially engaging connection which in turn contributes to an improvement of a sealed flange connection can also be achieved. The sealing element 7 is already secured for the assembly to a prewelding neck 3 of a pipe end, whereby it is ensured that it is not forgotten or lost, and that the wrong one is not mounted.

What is claimed is:

1. A flange connection (1) for connecting two pipeline ends made of plastics material containing two mutually opposing pipe ends (2) made of plastics material, comprising wherein the pipe ends (2) each have a prewelding neck (3), two loose type flanges (4), wherein a loose type flange (4) is arranged at each pipe end (2), wherein the loose type flanges (4) have holes (5) for mutual clamping, clamping means (6), wherein the clamping means (6) are arranged in the holes (5) and serve to mutually pull together the loose type flanges (4) and the pipeline ends, and a sealing element (7), wherein the sealing element (7) comprises a conductive plastics material and exclusively one material.

2. A flange connection (1) according to claim 1, wherein the sealing element (7) is constructed in one piece.

3. A flange connection (1) according to claim 1, wherein the conductive plastics material is constructed in a homogeneous manner.

4. A flange connection (1) according to claim 1, wherein exclusively the sealing element (7) is arranged between the mutually opposing prewelding necks (3).

5. A flange connection (1) according to claim 1, wherein the sealing element (7) comprises a conductive thermoplastic elastomer material (TPE).

6. A flange connection (1) according to claim 1, wherein the prewelding neck (3) is made of polyethylene (PE).

7. A flange connection (1) according to claim 1, wherein the prewelding neck (3) has grooves at the end face.

8. A flange connection (1) according to claim 1, wherein the grooves in the prewelding neck (3) are constructed as concentrically extending circles.

9. A method for assembling a flange connection (1) according to claim 1 comprising:
arranging the loose type flanges (4) at mutually opposing pipe ends (2) made of plastics material, clamping together the loose type flanges (4) using clamping means (6), wherein the clamping together is carried out only up to a slight pretensioning, applying electric current to a conductive sealing element (7), wherein the conductive sealing element (7) is arranged between the pipe ends (2) or the prewelding necks (3) on the pipe ends (2) in order to carry out a welding between at least one side of the sealing element (7) and a prewelding neck (3), subsequent clamping together of the loose type flanges (4) using clamping means (6) up to a required tightening torque, wherein the sealing element (7) is already arranged at the end face of a prewelding neck (3) in a non-releasable manner before the loose type flanges (4) are arranged on the mutually opposing pipe ends (2) and the clamping together is carried out.

10. A method for assembling a flange connection (1) according to claim 9, wherein the sealing element (7) can be released by heating the prewelding neck (3) again and, after the prewelding neck (3) and the sealing element (7) are cleaned, can be used again.
